(19) United States
(12) Patent Application Publication
(10) Pub. No.: US 2025/0305076 A1
(43) Pub. Date: Oct. 2, 2025

(54) Method For Conditioning The Surfaces Of Heat-Treated Galvanised Steel Sheets

(71) Applicants: voestalpine Metal Forming GmbH, Linz (AT); voestalpine Stahl GmbH, Linz (AT)

(72) Inventors: Siegfried Kolnberger, Pasching (AT); Florian Gerstner, Aalen (DE); Andreas Sommer, Abtsgmünd (DE); Ernst Schachinger, Linz (AT); Christoph Wagner, Pupping (AT); Rüdiger Heinritz, Schwäbisch-Gmünd (DE)

(73) Assignees: voestalpine Metal Forming GmbH, Linz (AT); voestalpine Stahl GmbH, Linz (AT)

(21) Appl. No.: 18/865,997

(22) PCT Filed: Sep. 23, 2022
(86) PCT No.: PCT/EP2022/076537

§ 371 Date: Nov. 14, 2024

(30) Foreign Application Priority Data
Jun. 28, 2022 (DE) 10 2022 116082.3

(51) Int. Cl. C21D 7/06; C21D 1/18; C21D 9/46

(52) U.S. Cl. CPC C21D 7/06; C21D 1/18; C21D 9/46; C21D 2211/001

(57) ABSTRACT

The invention relates to a method for conditioning the surfaces of heat-treated galvanized steel sheets or alloy-galvanized sheet steel components, wherein either a steel sheet is heated in at least some regions for the purpose of austenitization and then is formed into a sheet steel component and cooled at a speed above the critical cooling rate, or a steel sheet is first formed into a sheet steel component and then heated in at least some regions for the purpose of austenitization and after the austenitization in at least some regions, the sheet steel component is cooled at a speed above the critical cooling rate. In both cases, the surface of the sheet steel component then undergoes an airless blast cleaning, characterized in that the airless blast cleaning is carried out with an Almen intensity of between 0.05 mm N and 0.20 mm N.

### RELATED APPLICATIONS

This patent application is a 35 U.S.C. § 371 National Stage entry of PCT/EP2022/076537, filed Sep. 28, 2022, which in turn claims priority based on German Patent Application DE 10 2022 116 082.3, filed Jun. 28, 2022, the disclosures of which are incorporated herein by reference.

### FIELD OF THE INVENTION

The invention relates to a method for conditioning the surfaces of heat-treated galvanized steel sheets or sheet steel components.

### BACKGROUND OF THE INVENTION

It is known to produce components such as vehicle body components out of in particular galvanized steel sheets. For this purpose, a steel material is first melted and then cast, usually using the continuous casting process. The slab ingot produced in the continuous casting is then hot rolled into a steel strip in an intrinsically known way. Such a steel strip is also referred to as a hot strip.

At the end of the hot rolling process, the hot strip that has been rolled from the slab ingot is usually wound into a strip steel roll, which is also called a coil. For cold rolling purposes, this strip steel roll or coil is unwound again and correspondingly rolled out into a cold-rolled strip in a cold-rolling mill.

The cold-rolled steel strip is then provided with a zinc layer by means of a hot-dip galvanization or an electrolytic galvanization.

Both in hot rolling and in cold rolling, the material is reduced from the original thickness of the slab ingot to a desired target thickness, for example a target thickness of 0.5 to 2 mm, which causes the material to lengthen considerably so that after the cold rolling, the original slab ingot yields a steel strip of for example 2.7 km in length. This cold-rolled strip is wound onto a strip steel roll or coil, unwound again for the galvanization, and after the galvanization, is wound back into a strip steel roll or coil.

When forming or a forming step is mentioned below, this expressly does not refer to the thickness reduction during rolling.

It is also known to also produce steel strips of this kind from steel grades that are quench hardenable.

In quench hardening, a steel material is brought at least to a temperature at which an austenitization takes place, i.e. a conversion of the iron into gamma iron. If in a subsequent step, this steel phase is cooled at a cooling speed above the critical cooling speed, then martensite is formed from the gamma iron. Because of a carbon solubility, which differs from that of from gamma iron, a martensitic structure has a distorted structure, which results in a high internal stress and thus hardness.

It is also known to use the effect of quench hardening in the production of sheet steel components as well, in particular automotive components such as body components or structural components.

Two basic methods have become established for this.

In the first method, a sheet steel sheet bar is cut out of or cut off from the sheet steel strip and this sheet steel sheet bar, which is flat, is heated to the above-mentioned austenitization temperature and then placed into a forming tool in which the hot sheet steel sheet bar is formed into a component in one stroke, wherein because of the contact of the hot sheet with the relatively cooler forming tool, at the end of the forming in the closed tool, the heat from the sheet metal is dissipated into the tool at a speed greater than the critical hardening speed. Through hot forming in combination with hardening, the hot sheet bar is thus transformed into a hardened sheet steel component.

In the second method, a flat sheet steel sheet bar must be cut out of or cut off from a steel strip and this sheet steel sheet bar must be formed into a sheet steel semi-finished component in a conventional, in particular multi-step, forming process, most often mainly through a combination of deep drawing, trimming, and/or postforming. This semi-finished component is then heated to the austenitization temperature and the heated semi-finished component is inserted into a tool, wherein the tool has the contour of the semi-finished component or the final component and in this tool, while retaining or largely retaining the form of the semi-finished component, the semi-finished component is quench hardened in the closed tool by the contact of the tool surfaces against the semi-finished component because the heat is dissipated into the tool. In other words, the hardening transforms the hot semi-finished component into a hardened sheet steel component.

The first method is also referred to as press hardening or the direct process; the second method is also referred to as form hardening or the indirect process.

In both methods, coated steel sheets can be processed to produce hardened sheet steel components. It is in particular known to use galvanized steel sheets in both methods. Particularly suitable for this are zinc-based alloys, i.e. with zinc as an element with the highest percentage by weight in the coating. For example, zinc can be alloyed with aluminum, copper, chromium, nickel, or other elements. It is also known to use aluminum-based coatings such as aluminum-silicon alloys in the first method, i.e. in press hardening.

When “galvanized” or “galvanized steel sheets” are mentioned below, this always includes a zinc-based alloy.

With galvanized steel sheets, during the heat treatment for purposes of the press hardening or during the heat treatment for purposes of the form hardening, alloying reactions between the zinc and the steel substrate occur on the one hand, but on the other hand, changes in the surface also occur, which can include the formation of oxides composed of zinc, layer alloy elements such as aluminum, or elements that are contained in the steel such as iron or manganese.

Such surfaces, in this case oxide layers, can easily also be embodied as glass-like in this case.

It is customary for such surfaces to be conditioned and particularly cleaned before delivery and in particular before other processing steps.

Various conditioning methods for this have been developed in the prior art, which are usually blasting methods in which for example dry ice or other blasting mediums such as solids are used to blast the surface.

This is carried out particularly in order to ensure product properties with regard to welding, painting, gluing, and corrosion.

Currently, these surfaces are most often conditioned using so-called airless blast cleaning (ABC); other methods are also known, in particular dry ice cleaning or also slide grinding, honing, and others.

To verify the conditioning action of the above-indicated methods on the surface as part of quality assurance, it is known to test the surface using direct, destructive, and also expensive and time-consuming testing methods. These include, for example, paint adhesion tests, welding tests, corrosion tests, glue-adhesion tests, and others.

Nondestructive, indirect, and less expensive testing methods are also known, some of which can also be carried out in conjunction with series production. In this case, for example, the transition resistance value is measured, the surface is compared to optical limit samples, the result of an adhesive strip pull-off test is compared to limit samples, or a wiping test is performed.

When it comes to assessing the effect of conditioning methods on the surface, however, these indirect, less expensive testing methods are considerably less informative than the direct, destructive, and expensive methods. For example, surfaces of hardened components have low transition resistance values that are equivalent to those of conditioned surfaces in which a conditioning of the surfaces that is sufficient to assure component quality has not taken place. This can be the case, for example, if surfaces of sheet bars or preformed components have undergone short to medium furnace dwell times for purposes of austenitization.

DE 40 36 568 C2 has disclosed a system for blasting and matting sheet metals, which are particularly intended for blasting and matting large-format, thin-walled sheet metals using a blasting medium such as sand, glass beads, metal, or the like. In this case, at least two blasting devices are provided, which are used to blast portions of the metal sheets being processed, which are oriented in a vertical processing plane, wherein the blasting devices act on the two opposite surfaces of the vertically oriented sheets equally with blasting medium projected at exactly opposing subregions of the surface.

EP 1 630 244 B2 has disclosed a press-hardened product and a manufacturing method for producing it, wherein the product has a zinc-based coating layer on its surface, which contains an iron-zinc solid solution phase and has a thickness of at least 1 μm and at most 50 μm, wherein a zinc oxide layer with an average thickness of at most 2 μm should be present on it, which is to be reduced in a step of the process. The thickness of the zinc oxide layer is to be reduced by means of a cast steel blasting and liquid honing.

DE 10 2007 022 174 B3 has disclosed a method for producing and removing a temporary protective layer for a cathodic coating, in particular for manufacturing a hardened steel component with a favorably paintable surface; this temporary layer is a zinc layer on the surface of the steel sheet and contains high oxygen affinity elements in a quantity of 0.1-15 wt %, which form a thin skin composed of the oxide of the high oxygen affinity elements during the austenitization and after the hardening, the sheet metal component is blasted with dry ice particles to blast away this oxide layer.

DE 10 2010 037 077 B4 has also disclosed a method for conditioning the surface of hardened corrosion-protected components made of sheet steel in which a slide grinding is carried out to condition the surface of the metallic coating, i.e. the corrosion protection layer; the corrosion protection coating is a zinc-based coating and the surface conditioning is carried out so that oxides contiguous to or adhering to the corrosion protection layer are stripped off and zinc-iron-phases that are present in the corrosion protection layer are abraded and their microporosity is exposed, but the corrosion protection coating is basically not stripped off.

EP 2 233 598 B1 has disclosed a method for producing a coatable and/or joinable formed sheet metal part with a corrosion protection coating in which, after a hardening is carried out in which a temporary protective layer forms on the corrosion protection coating, this temporary protective layer is at least partially removed from the formed sheet metal part by means of cleaning blasting with an abrasive blasting material and/or through mechanical cleaning, wherein the corrosion protection coating should be essentially retained.

DE 10 2020 105 046 B4 has disclosed a method for manufacturing a flat steel product and the use of such a flat steel product, wherein the flat steel product is to undergo blast treatment, wherein the flat steel product is moved continuously relative to a blast treatment system that directs a blasting material jet against at least one surface of the flat steel product for a blasting duration of from 0.03 minutes to 2 minutes, wherein the blasting material of the blasting material jet consists of particles with an average diameter of 0.05-4 mm and the impact velocity of the particles is at least 50 m/sec so that after the flat steel product has passed through the length of the impact zone, predetermined roughness values are present on the surface that has been exposed to the blasting material jet.

On the surfaces of galvanized steel sheets, particularly on the oxide layers that form during the heat treatment for purposes of austenitization and thus particularly with average to longer furnace dwell times, it is problematic that these do not always have the optimal characteristics, wherein in particular loosely adhering oxides must either be reliably removed or their adhesion must be increased.

There are also no simple testing methods for obtaining sufficient information about surface states with regard to the conditioning quality, e.g. under microscope in the top view of the surface or in the transverse section. The current methods that provide more or less reliable information are destructive, expensive, and time-consuming methods, which are unsuitable for being carried out in conjunction with series production. By contrast, the known non-destructive testing methods for quality assurance are not sufficiently precise and informative. For example, components that have sufficiently low transition resistances still lead to negative results for example on the corrosion test, the paint-adhesion test, the potentiostatic-cathodic polarization, or the galvanostatic-cathodic polarization. In addition, unwanted limitations in the manufacturing process can arise in this connection, e.g. a reduced welding processing window.

### SUMMARY OF THE INVENTION

The object of the invention is to create a method for conditioning the surface of a heat-treated galvanized material with which a high surface quality and reproducible results are achieved and which is inexpensive to use.

The object is attained with a method having the features described and claimed herein.

Advantageous modifications are also described and claimed herein.

According to the invention, in the airless blast cleaning, a certain blasting intensity is achieved by means of the blasting material used, also known as blasting medium, and/or by means of system parameters such as the turbine speed and/or throughput speed, wherein the grain size distribution of the blasting medium used for the blasting is determined by means of sieve analysis and is set to a particular value range. In addition, success can be adequately proven on a blasted specimen by assessing a transverse section; furthermore, a certain degree of coverage can likewise be determined by inspecting the top view of the surface under a reflected-light microscope. By determining and setting the above-mentioned parameters, it succeeds in achieving an outstanding optimization of the surface conditioning and customization to fit the respective technical and production-related circumstances.

It has turned out that setting the blasting intensity to particular values has a significant influence on the success.

It is known to determine the blasting intensity by means of so-called Almen test strips. The Almen test strips, which are made of spring steel, are available in three different thicknesses referred to as “N,” “A,” and “C” strips; “N” strips are 0.79 mm thick, “A” strips are 1.29 mm thick, and “C” strips are 2.39 mm thick. The Almen test strips are clamped into a holder, which is fastened, for example by welding, to the position to be tested on the test sheet or test component and is blasted on one side together with the test sheet or test component with the settings that are to be tested. As a result, the Almen test strips arch toward the blasted side. The resulting arch height of the strip is measured using a meter and is indicated as a blasting intensity value expressed in mm. In this connection, the Almen measuring strip used must always be mentioned at the same time, e.g. intensity=0.25 mm A.

In the prior art, for heat-treated coated vehicle body components made of sheet steel, comparatively low blasting intensities of less than 0.04 mm N Almen are achieved in the airless blast cleaning because of comparatively high throughput speeds that are chosen for reasons of cost efficiency, combined with non-optimally selected settings.

The Almen intensity according to the invention is greater than 0.05 mm N, preferably greater than 0.10 mm N, and even more preferably greater than 0.15 mm N, but less than 0.2 mm N. Correspondingly, in this case the Almen type “N” is used in class 1 with a thickness of the strip of 0.79 mm in the case of the invention. Class 1 defines the prebending, i.e. the +/−0.025 mm, as the maximum. The length and width of the strip are 76.1×19.0 mm, the hardness in type “N” is 72.5-76 HRA; the measurement is performed in accordance with SAE AMS 2430.

The blasting intensity should not be set too low in order to reliably reduce surface regions without oxide adhesion or with poor oxide adhesion and to reliably break up pronounced cavities bridged by oxides, so-called domes, which are particularly produced with average to high oven dwell times. For reasons of cost efficiency, this should also be done at the highest possible throughput speeds.

The blasting intensity, however, should also not be set too high since otherwise, the grains of the blasting medium wear out too quickly and/or the components are excessively deformed with regard to the given dimensional accuracy requirements and/or the zinc-iron layer is damaged.

According to the invention, it has been discovered that both requirements are met to a very favorable degree at blasting intensities of between 0.05 mm N Almen and 0.20 mm N Almen.

With regard to the blasting medium used, it is advantageous if 50% of the grains have a grain size of greater than or equal to 0.30 mm and the maximum grain size is less than 0.70 mm. A regular sieve analysis is advantageous in order to keep the fraction of coarse grains consistently high. It has turned out that a fraction of >50% of the grains with a grain size of greater than or equal to 0.30 mm is preferable. This can further improve the surface conditioning.

Preferably round grains are used as the blasting medium instead of angular grains. It has been determined that round grains wear out less quickly and the system wears out less quickly.

Basically, any granular material can be used for this as long as the hardness of the grain is customized and preferably lies between 450 and 520 HV.

It has been determined that with these settings, the consumption of blasting medium over time can be significantly lower than in the prior art.

In a preferred embodiment, the turbine speed can lie in a range between 1200 and 2500 rpm, for example. Particularly preferably, the speed can be between 1500 and 2000 rpm. The blade shape of the turbines used to hurl the blasting medium at the component surfaces that are to be conditioned can preferably be chosen to be flat; this can offer advantages in the durability of the turbine blades since it can reduce wear on them.

In a preferred embodiment, the throughput speed of the components through the blasting process can be 4 to 16 m/min, for example. A high throughput speed can increase the output.

In this connection, the inventors have surprisingly discovered that for example through a suitable choice of the blasting medium, a sufficiently high Almen intensity can still be achieved, even with a comparatively low turbine speed and a comparatively high throughput speed.

The conditioning success of blasted specimens and/or components can be verified, for example, in the transverse section. In this case, on the one hand, the percentage of regions with non-contiguous or non-adhering oxides over the section length can be determined and on the other hand, the depth of the cavities bridged by oxides can be measured. If one or both of the values is/are excessive, then this can in particular be problematic for the paint adhesion in subsequent processes.

Preferably, in the transverse section, the fraction of the surface area occupied by regions with cavities under the oxide layer, i.e. regions without contiguous oxides, comprises at most 35%, particularly preferably at most 15% of the surface area.

Preferably, the fraction of adhering oxides can be at least 65%, particularly preferably at least 85% of the surface area.

In addition or alternatively to the percentage of non-contiguous oxides, preferably at most one pronounced cavity deeper than 10 μm should be present on the surface under the oxide layer for each 400 μm of section length in the transverse section.

The preparation of the transverse sections must be carried out carefully, i.e. preferably the oxide structure should be essentially retained and any cavities that are present should not be filled or removed during the preparation of the transverse sections since otherwise, the above-mentioned values could be distorted.

The conditioning success of blasted specimens and/or components can be verified by means of the degree of coverage, i.e. the fraction of the surface area that has been acted on with blasting medium during the blasting as compared to the total surface area. The degree of coverage can alternatively or additionally be determined by means of light microscopy or by means of scanning electron microscopy (SEM) in the top view of the surface.

### BRIEF DESCRIPTION OF THE DRAWINGS

The invention will be explained by way of example based on the drawings. In the drawings:

FIG. 1: shows Almen N blasting intensities of different combinations of turbine speed and throughput speed according to the prior art and according to the invention;

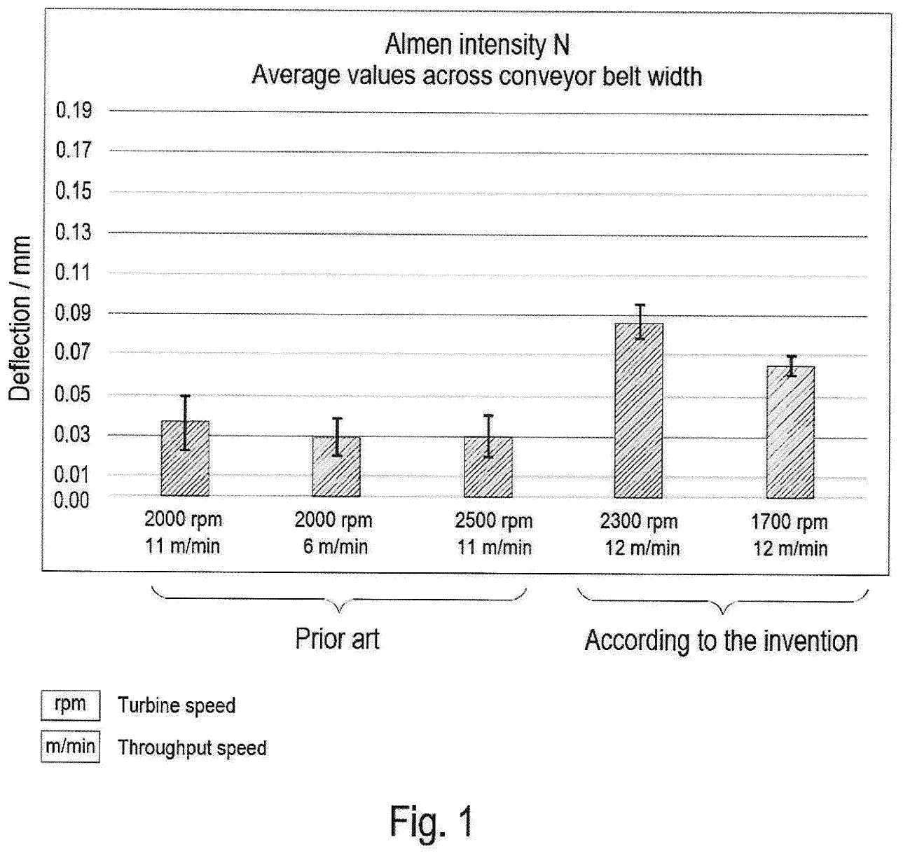

FIG. 2: shows grain size distributions of the blasting medium according to the invention and according to the prior art;

FIG. 3: shows the loss rates of blasting medium as a function of the number of blasting cycles according to the invention and according to the prior art;

FIG. 4: is a transverse section showing a heat-treated surface with a percentage evaluation of areas with non-adhering oxides outside the tolerance range;

FIG. 5: is a transverse section showing a heat-treated surface with a percentage evaluation of areas with non-adhering oxides within the tolerance range;

FIG. 6: is a transverse section showing a heat-treated surface without regions of non-adhering oxides within the tolerance and with filled cavities;

FIG. 7: is a transverse section showing a heat-treated surface with pronounced cavities bridged by oxides or so-called domes;

FIG. 8: shows a comparison of microscopic top views with a suitable degree of coverage of 64% according to the invention and with an unsuitable degree of coverage of 35%;

FIG. 9: is a section showing a galvanized 22MnB5 steel with a Z140 zinc coating before the hardening;

FIG. 10: is a comparison of surface images showing a galvanized 22MnB5 steel with a Z140 zinc coating, which is heat-treated, conditioned, and coated by means of cathodic dip painting (CDP); with suitable conditioning after 10 weeks according to standard VDA-old showing no rust spots and with unsuitable conditioning after 10 weeks of VDA-standard aging showing rust spots caused by crater formation in the CD paint;

FIG. 11: shows a crater in the CD paint layer (before 10 weeks according to standard VDA-old) in a top view and in profile;

FIG. 12: shows a crater in the CD paint layer (before 10 weeks according to standard VDA-old) in a transverse section.

### DETAILED DESCRIPTION OF THE INVENTION

It has surprisingly turned out that by contrast with conventional assumptions, it is not necessary to completely remove the oxides in order to ensure a good surface quality for subsequent processes. It has also surprisingly turned out that it is not disadvantageous for oxides in cavities of the surface to be pushed together and compressed; instead, an evening-out of the surface by means of the airless blast cleaning is on the contrary advantageous because it likewise reduces the tendency for craters to form in the CD paint layer.

According to the invention, this is successfully achieved if the blasting intensity is precisely selected to be between 0.05 mm N and 0.20 mm N, expressed as an Almen intensity.

It is also advantageous if with regard to the granulation of the blasting medium, sieve analysis is used to set the granulation so that 50% of the grains have a size of at least 0.3 mm and up to at most 0.7 mm.

As a result, the transverse section of the blasted specimen should yield an image in which regions with non-adhering oxides comprise at most 35% of the section length and there is at most one single pronounced cavity bridged by oxides with a total depth greater than 10 μm in the section length of 400 μm.

In this case, the intent is preferably to achieve a degree of coverage of at least 50%. The degree of coverage in this case is defined as the fraction of the surface area on the component that has actually been acted on with the blasting medium as compared to the total surface area. It has surprisingly turned out that a degree of coverage of 100% is disadvantageous and the optimum is surprisingly a degree of coverage between 60% and 90%.

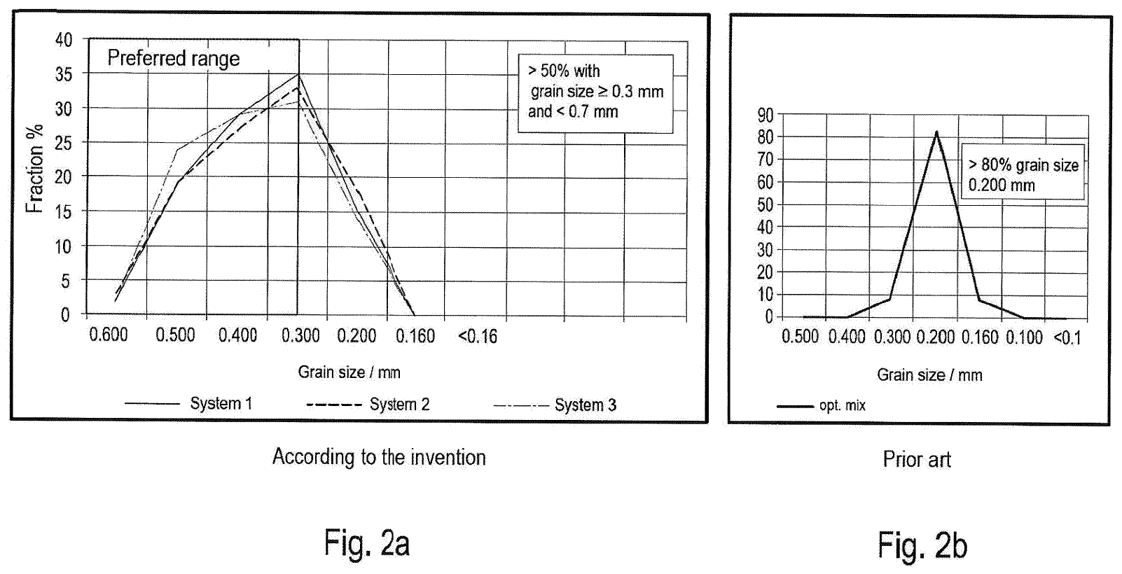

FIG. 2a shows grain size distributions according to the invention; the fraction of grains with a diameter of 0.3 mm to 0.6 mm is greater than 50%. This requires a corresponding separation of the worn out grains and a replenishment of fresh grains to be carried out in order to maintain this fraction during ongoing operation.

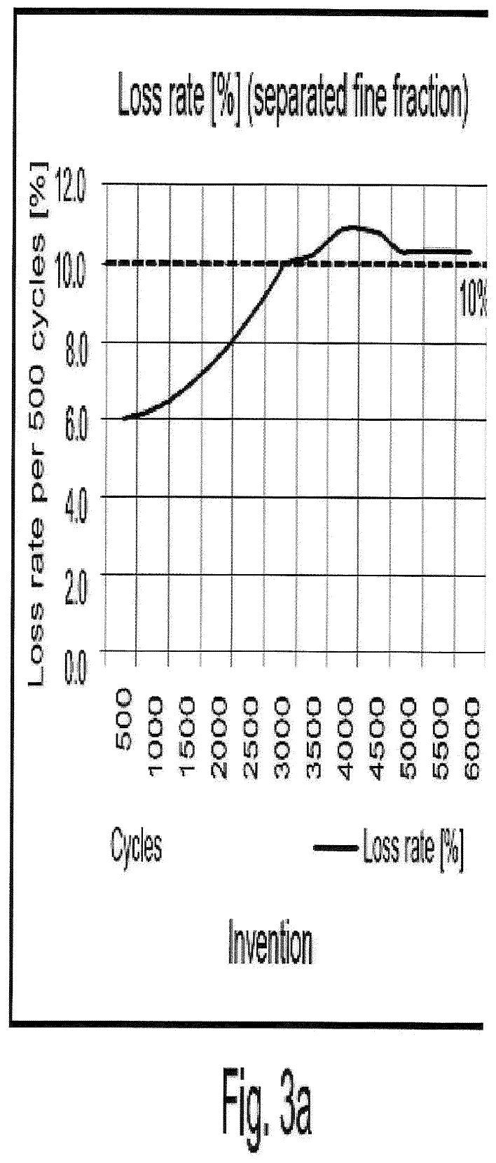

FIG. 3 shows the loss rates of the blasting medium from laboratory tests; it is clear that in the prior art (on the right), the loss rates that are expressed here as the fine fraction that is separated out in the method (grain size <0.15 mm), which rates occur due to the wearing out of the blasting medium, are significantly higher than with the invention (on the left) in which, due to the choice of the blasting medium, there is quite clearly an increased stability in terms of wear. In this case, the testing was performed until 100% of the original blasting medium had worn out, i.e. the original weight used had worn out. For the test, after 500 cycles, the blasting medium used was replaced with fresh blasting medium. It is clear that in the example according to the invention, it was possible to carry out 6000 cycles before 100% of the original blasting medium wore out, whereas in the test of the prior art, this value had already been reached after 4500 cycles. This corresponds to a lengthening of the use duration by ⅓.

This is also attributable to the use of round grains as proposed according to the invention.

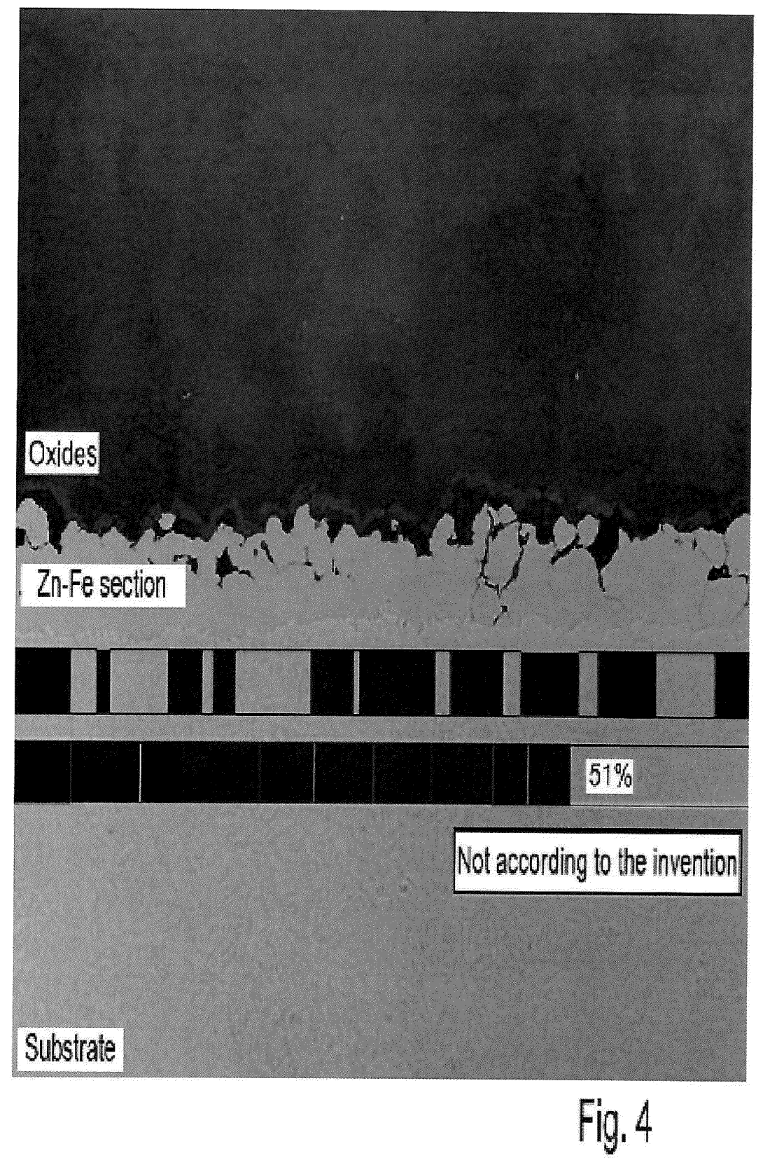

FIG. 4 shows the transverse section of a steel substrate with a contiguous zinc-iron layer topped by regions of adhering oxides and regions of non-adhering oxides and overall, a comparatively jagged surface. In the regions with non-adhering oxides, indicated with black blocks in the lower part of the image for purposes of the percentage evaluation, pronounced cavities under the oxides, so-called domes, are visible in some areas. The regions with non-adhering oxides in this case, after being added together, constitute 51% of the section length and therefore exceed 35% of the section length. Such a surface is unsatisfactory for the subsequent processing steps.

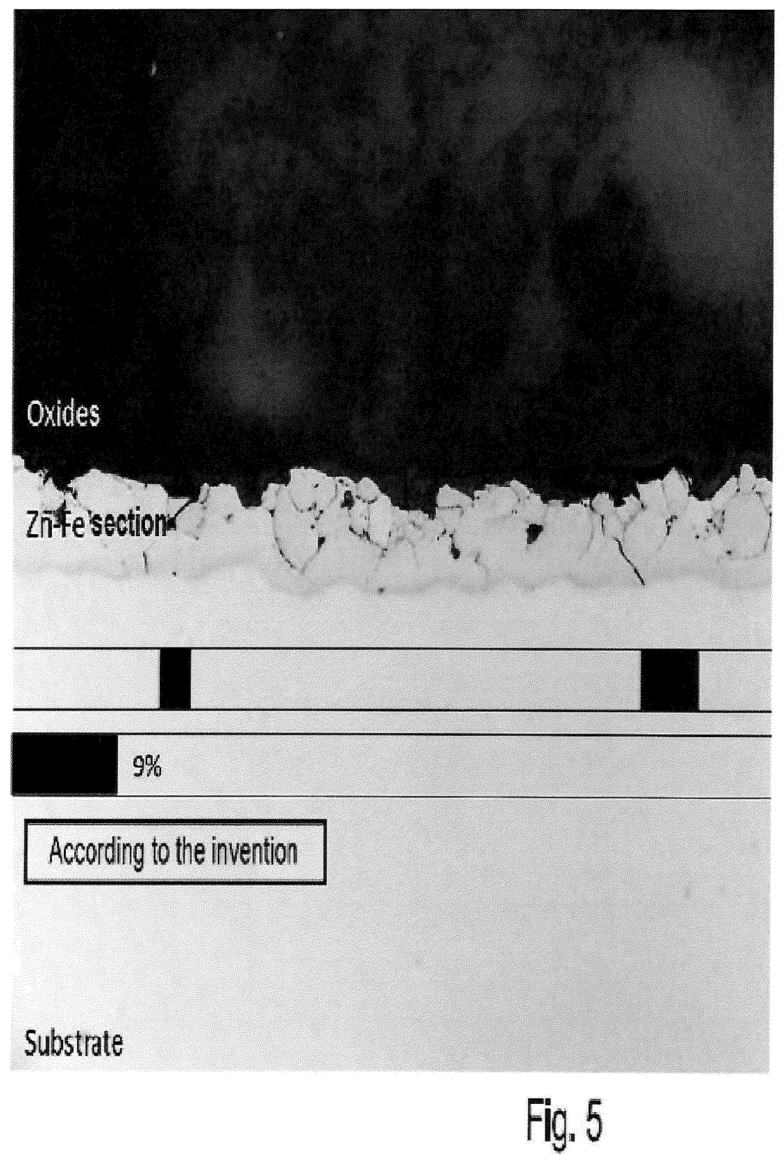

FIG. 5 shows a comparable section view, in which significantly fewer regions with non-adhering oxides are visible, suggesting that such a surface would be satisfactory.

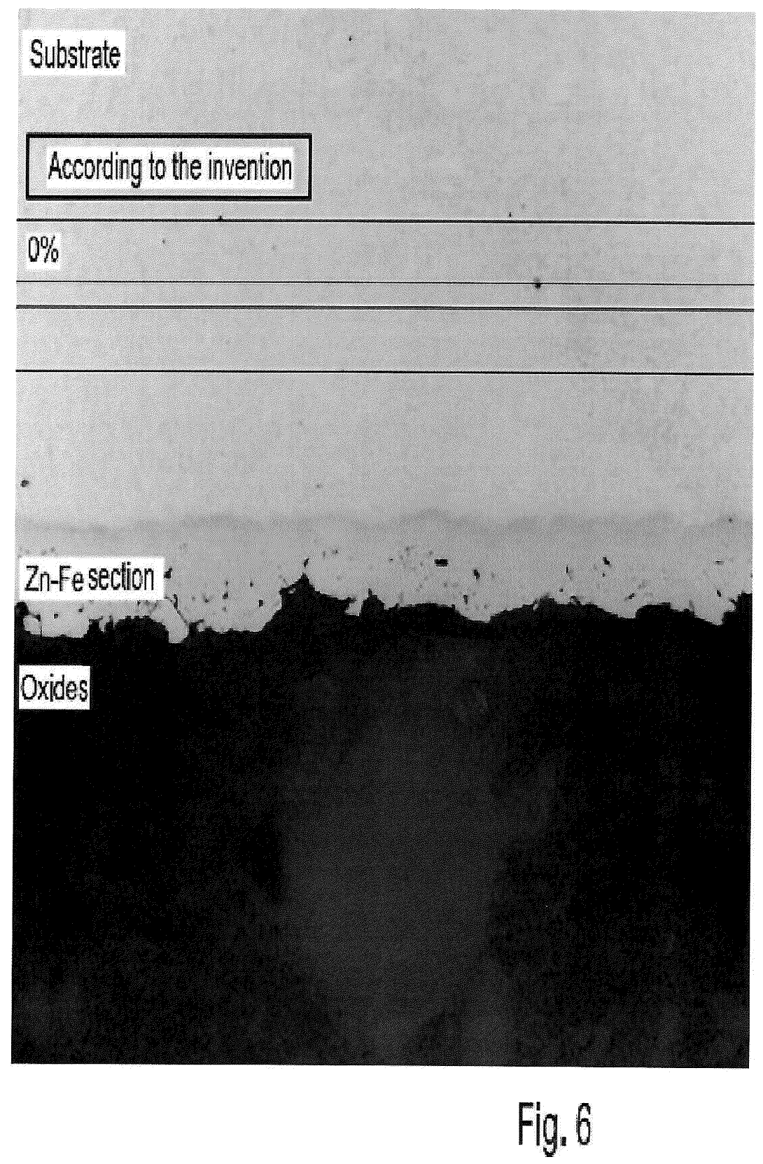

FIG. 6 shows a surface that has been optimized and conditioned according to the invention. It is clear that this surface exhibits very little jaggedness; in this case, the airless blast cleaning used according to the invention has pushed oxides—which may possibly also have been detached by the airless blast cleaning or else were resting loosely—into cavities and jagged parts of the surface and compacted them there and in this respect, has produced a smooth or comparatively smooth surface.

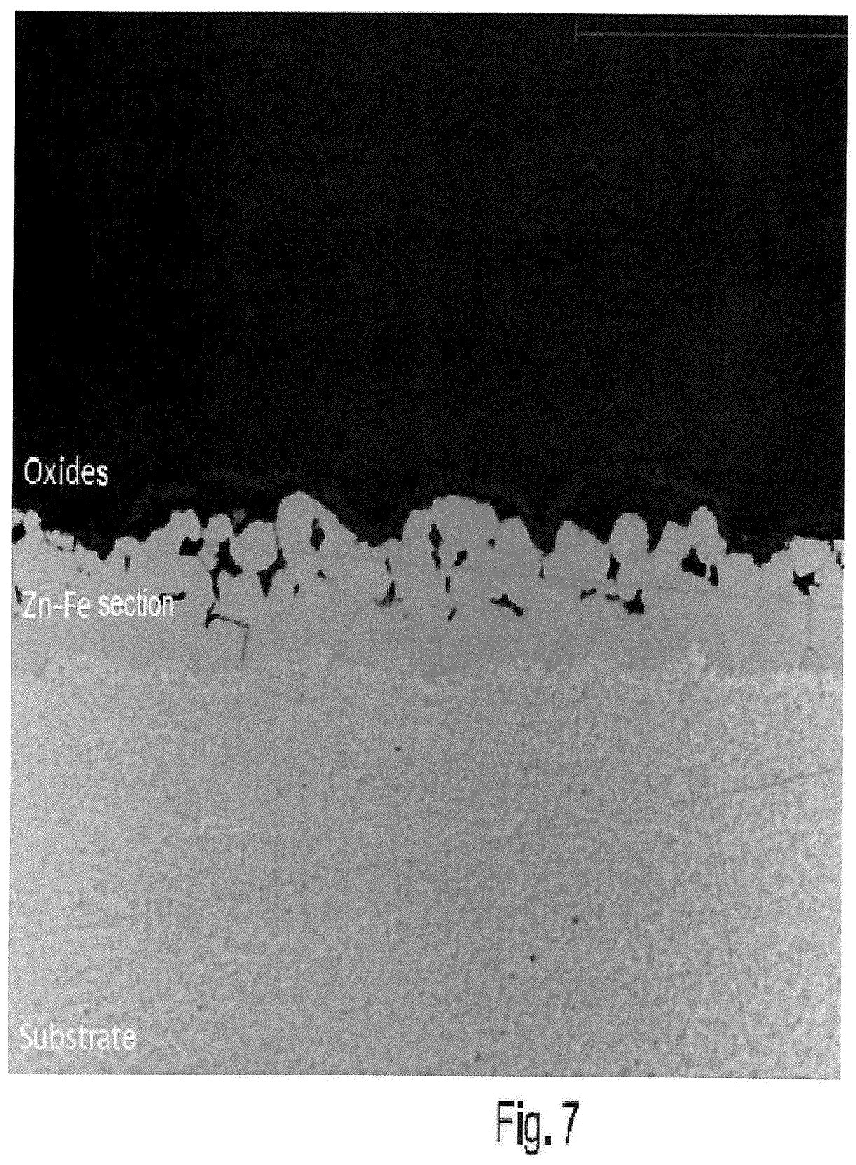

In FIG. 7, pronounced cavities bridged by oxides, so-called domes, are visible in the transverse section.

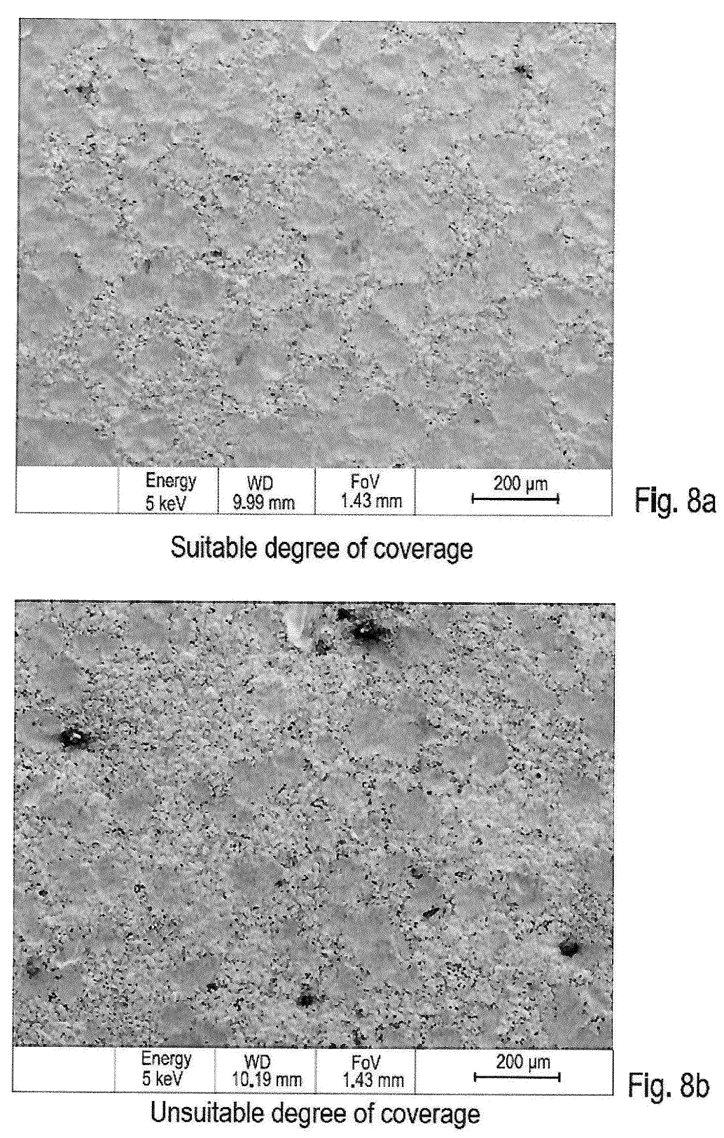

FIG. 8a shows the microscopic top view of a surface, which has a degree of coverage of 63%; in other words, 63% of the surface has been acted on by blasting medium. This is a good surface similar to the one shown in FIG. 6 (shown in transverse section there).

By contrast, FIG. 8b shows the microscopic top view of a surface of which only 33% has been acted on by blasting medium, which is not sufficient for good use properties. It is clear that the fraction of entirely unaffected regions is very high (67%). If components with such surfaces are CD painted, then in these regions, paint adhesion can be poor, either because Al oxides are present there, which have a poor phosphating capacity, and/or because in these regions, oxides are not bonded flush with the metallic layer and the paint, together with these oxides, loses its adhesion. In addition, there can be an elevated tendency for crater formation in the CD paint in these regions.

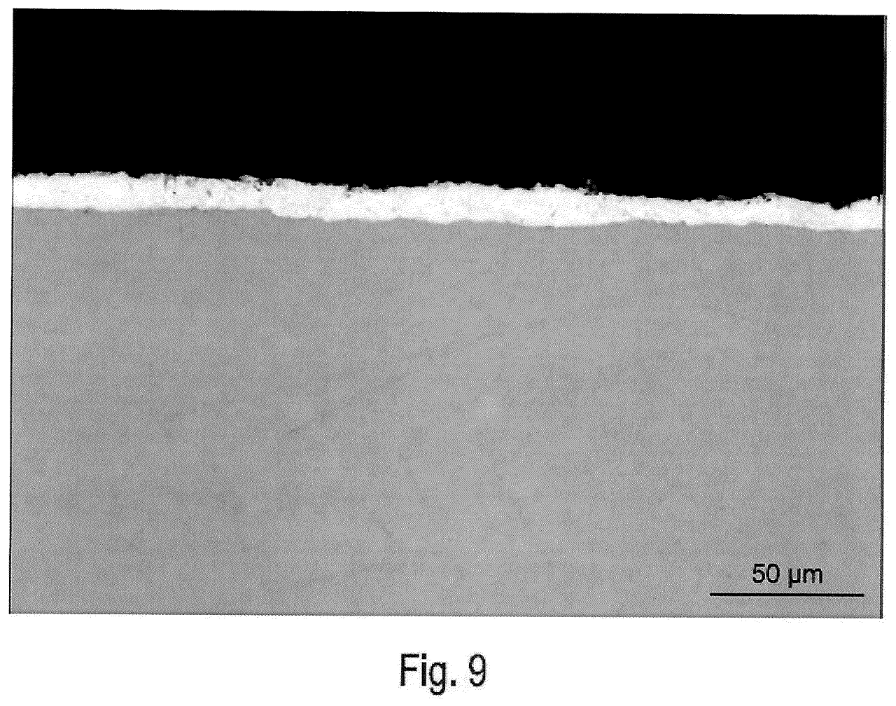

FIG. 9 is a section showing a galvanized hardenable steel that is provided with a Z140 zinc coating, before the hardening.

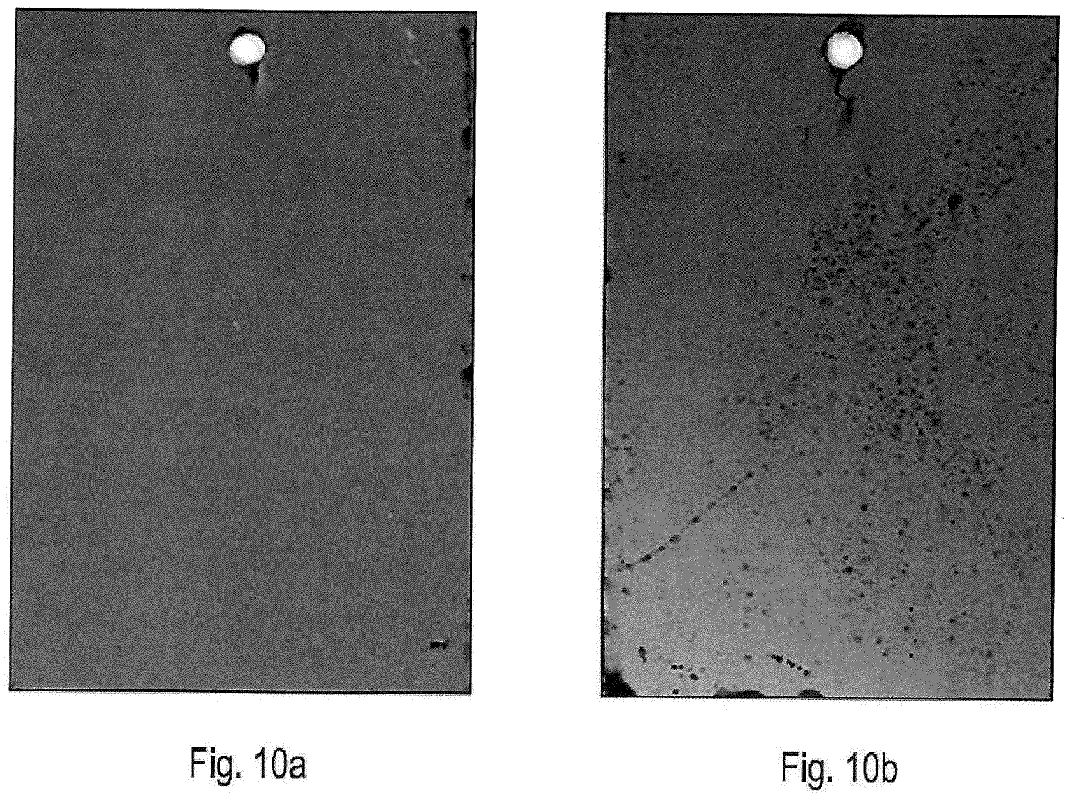

With treatment not according to the invention, as described above, poorly adhering oxides can remain on the surface and craters can form in the CD paint layer, which weaken it locally. The consequences of such craters or other surface defects are shown in FIG. 10a and FIG. 10b. Here, it is clear that corrosion first begins in these locations if the conditioning has not been performed according to the invention.

FIG. 10a shows the surface image after a VDA 621-415 corrosion test, without rust spots, for a sheet on which the conditioning was performed according to the invention.

By contrast, FIG. 10b shows the surface image after the same corrosion test for a sheet that was not conditioned according to the invention. It is clear that without an appropriate conditioning of the surface, a significantly increased damage due to rust spots occurs.

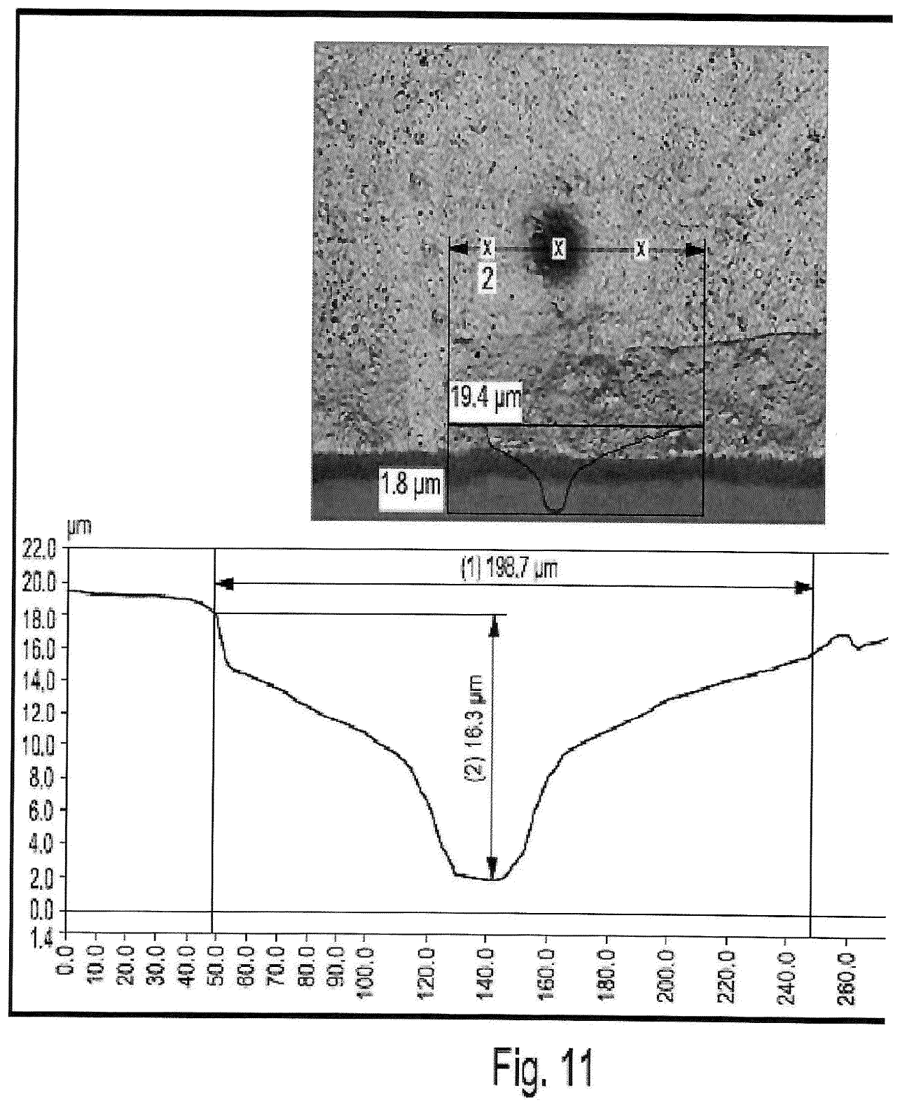

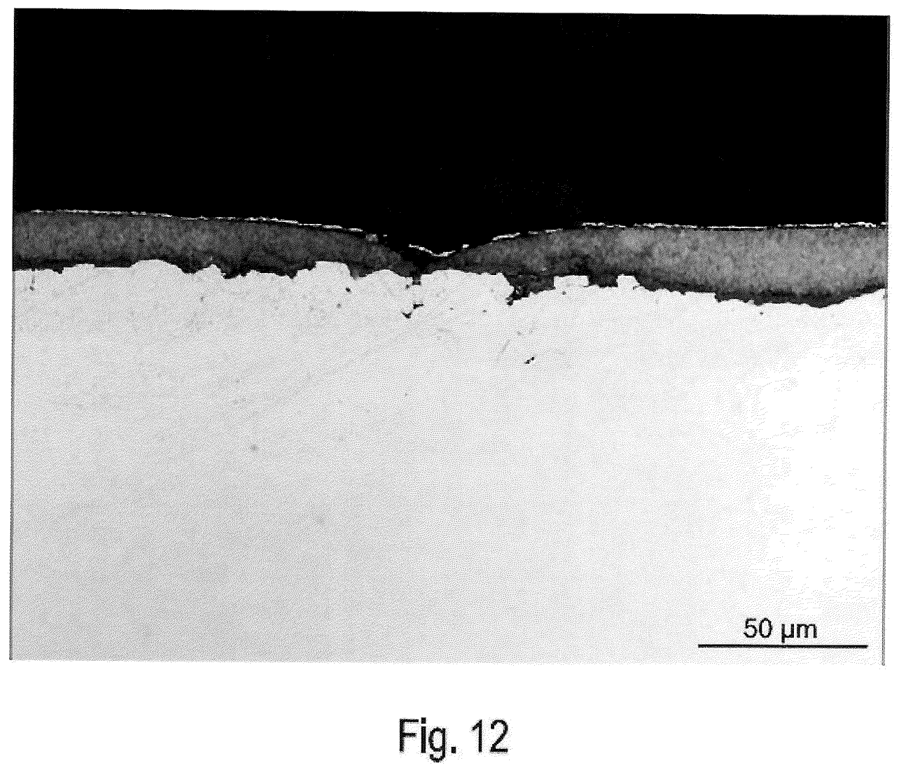

FIGS. 11 & 12 show corresponding craters that locally weaken the CD paint layer and occur without a sufficient surface conditioning. A corresponding transverse section is shown in the section view in FIG. 12.

This demonstrates the need for conditioning the surface; the surface conditioning according to the invention improves the surface regardless of the furnace dwell time so much that the above-indicated disadvantages, both in subsequent processing steps and also in terms of corrosion impact, do not occur.

In this connection, it has turned out that the conditioning of the surface with airless blast cleaning within the indicated parameters results in adding a high degree of flexibility because regardless of the furnace dwell time, the conditioning is always reliably achieved without damaging the surface. This is particularly important because in practice, the furnace dwell times vary due to delays or stoppages that occur in real processes.

The invention thus achieves a method for conditioning surfaces, which can be carried out reliably, simply, and inexpensively and leads to a significant reduction in waste and to a higher quality.

1-15. (canceled)

16. A method for conditioning the surface of heat-treated galvanized or alloy-galvanized steel sheet components, comprising the steps of:
a) heating a steel sheet is heated in at least some regions to cause austenitization, then forming the steel sheet into a sheet steel component and cooling the steel sheet component at a speed above a critical cooling rate of the steel sheet component;
b) or, as an alternative to a), forming the steel sheet into a steel sheet component, then heating the steel sheet component in at least some regions to cause austenitization and cooling the steel sheet component at a speed above the critical cooling rate of the steel sheet component; and
c) after performing one of a) and b), subjecting at least a portion a surface of the steel sheet component to an air blast cleaning using a granular blasting medium and an Almen intensity of between about 0.05 mm N and about 0.20 mm N.

17. The method according to claim 16, wherein at least about 50% of the blasting medium has grain sizes greater than or equal to 0.30 mm.

18. The method according to claim 16, wherein the blasting medium comprises round grains.

19. The method according to claim 16, wherein the blasting medium comprises grains having a hardness of between 400 HV and 550 HV.

20. The method of claim 19, wherein the grains have a hardness between 450 HV and 520 HV.

21. The method of claim 16, wherein the air blast cleaning is performed using an Almen intensity of between 0.1 mm N and 0.15 mm N.

22. The method of claim 16, wherein the portion of the surface that is subjected to the air blast cleaning is between 50% and 95% of a total area of the surface.

23. The method of claim 16, wherein the surface has an oxide layer prior to the air blast cleaning, and the air blast cleaning is performed so that regions in a transverse section of the surface having no oxide adhesion constitute not more than 35% of a length of the section.

24. The method of claim 16, wherein the surface has an oxide layer prior to the air blast cleaning, and the air blast cleaning is performed so that adhering oxides cover at least 65% of an area of the surface.

25. The method of claim 16, wherein the surface has an oxide layer prior to the air blast cleaning and air blast cleaning is performed so that at most, one single cavity deeper than 10 μm is present in a section of the surface under the oxide layer for each 400 μm of section length in a transverse section.

26. The method of claim 16, wherein the blasting medium is devoid of grains having a diameter greater than 0.7 mm.

27. The method of claim 16, wherein the air blast cleaning is performed using a turbine speed in a range from 1200 rpm to 2500 rpm.

28. The method of claim 16, wherein the air blast cleaning is performed using a throughput speed of sheet steel components through the blasting process of 4 m/min to 16 m/min.

29. The method according to claim 16, wherein the sheet steel components have the following steel composition (all values indicated in wt. %):
up to 0.4 carbon,
up to 1.9 silicon,
up to 3.0 manganese,
up to 1.5 chromium,
up to 0.9 molybdenum,
up to 0.9 nickel,
up to 0.2 titanium,
up to 0.2 vanadium,
up to 0.2 tungsten,
up to 0.2 aluminum,
up to 0.01 boron,
up to 0.01 sulfur,
up to 0.025 phosphorus,
residual iron and impurities.

30. A method for conditioning the surface of heat-treated galvanized or alloy-galvanized sheet steel components, comprising the steps of:
a) heating a steel sheet is heated in at least some regions to cause austenitization, then forming the steel sheet into a sheet steel component and cooling the steel sheet component at a speed above a critical cooling rate of the steel sheet component;
b) or, as an alternative to a), forming the steel sheet into a steel sheet component, then heating the steel sheet component in at least some regions to cause austenitization and cooling the steel sheet component at a speed above the critical cooling rate of the steel sheet component; and
c) after performing one of a) and b), subjecting at least a portion a surface of the steel sheet component to an air blast cleaning using a granular blasting medium and an Almen intensity of between about between about 0.1 mm N and about 0.15 mm N;
wherein the sheet steel components have the following steel composition (all values indicated in wt. %):
0.15 to 0.3 carbon,
0.11 to 1.5 silicon,
0.8 to 2.5 manganese,
0.1 to 0.9 chromium,
0.1 to 0.5 molybdenum,
up to 0.9 nickel,
0.02 to 0.1 titanium,
up to 0.2 vanadium,
up to 0.2 tungsten,
0.02 to 0.07 aluminum,
0.0005 to 0.005 boron,
up to 0.008 sulfur,
up to 0.01 phosphorus,
residual iron and impurities.

31. The method of claim 30, wherein the portion of the surface that is subjected to the air blast cleaning is between 60% and 90% of a total area of the surface.

32. The method of claim 30, wherein the surface has an oxide layer prior to the air blast cleaning, and the air blast cleaning is performed so that regions in a transverse section of the surface having no oxide adhesion constitute not more than 15% of a length of the section.

33. The method of claim 30, wherein the air blast cleaning is performed using a turbine speed in a range from 1500 rpm to 2000 rpm.

34. A hardened steel component with a zinc-based coating, wherein the steel component has a surface that has been conditioned using an airless blast cleaning according to the following steps:
a) heating a steel sheet is heated in at least some regions to cause austenitization, then forming the steel sheet into a sheet steel component and cooling the steel sheet component at a speed above a critical cooling rate of the steel sheet component;
b) or, as an alternative to a), forming the steel sheet into a steel sheet component, then heating the steel sheet component in at least some regions to cause austenitization and cooling the steel sheet component at a speed above the critical cooling rate of the steel sheet component; and
c) after performing one of a) and b), subjecting at least a portion a surface of the steel sheet component to an air blast cleaning using a granular blasting medium and an Almen intensity of between about between about 0.05 mm N and about 0.20 mm N;

35. The hardened steel component according to claim 34, wherein the hardened steel component has at least one section having a section length, and most one single cavity deeper than 10 μm for each 400 μm of section length in a transverse section.
